(19) United States
(12) Patent Application Publication
(10) Pub. No.: US 2003/0186749 A1
(43) Pub. Date: Oct. 2, 2003

(54) Flexible couplings

(75) Inventor: Anthony L. Hauck, Santa Ana, CA (US)

Correspondence Address: PAUL, HASTINGS, JANOFSKY & WALKER LLP, 12390 EL CAMINO REAL, SAN DIEGO, CA, 92310, US

(73) Assignee: ATR Sales, Inc.

(21) Appl. No.: 10/107,285

(22) Filed: Mar. 26, 2002

(51) Int. Cl. F16D 3/64; F16D 3/78

(52) U.S. Cl. 464/75

(57) ABSTRACT

A flexible coupling including a first hub having an inner face, a flexible insert having a plurality of exterior lobes and a plurality of interior lobes, a retainer ring having an interior which engages the exterior lobes of the flexible insert, and a second hub having an exterior surface contoured to engage the interior lobes of the flexible insert.

### BACKGROUND OF THE INVENTION

1. Field of the Invention

The invention set forth in this specification pertains to new and improved flexible couplings and, more particularly, to such couplings having advantageous features of both shear and compression style couplings.

2. Description of Related Art

Flexible couplings have long been used for the purpose of transmitting rotation from one shaft to another. Such couplings are normally used in order to accommodate comparatively minor shaft alignment problems such as are occasionally encountered because of manufacturing or assembly errors. Because of the fact that these devices are widely used and have been known and used for many years, many different types of flexible couplings have been proposed, built, and used.

Certain particular flexible couplings have been manufactured in the past so as to include two hubs or hub elements which are adapted to be connected to the shafts joined by the coupling. These hubs are each provided with extending lugs, teeth, or ribs serving as holding means so as to be engaged by corresponding projections on a band-like or belt-like motion transmitting means in order to cause the hubs to rotate in synchronism as one of the shafts is rotated. The bands or belts used in these prior couplings have been flexible, somewhat resilient belts capable of being wrapped around the hubs so that the projections on them engage the holding means on the hubs.

A metal band or ring is typically used to retain the belt in position wrapped around the hubs. The interior of the band is shaped and dimensioned so that the band may be slid axially relative to the hubs during the assembly and disassembly of the coupling so that the band fits over the belt when the coupling is assembled so as to conform closely to the exterior of the belt.

Some coupling designs have provided a pair of oppositely-disposed axial grooves in the outer surface of the belt and a pair of oppositely-disposed pins in the inner surface of the metal band. The pins are located so as to slide into the grooves as the metal band is installed along a line parallel to the axis of rotation of the hubs. The pins thus position the band and provide a degree of retention. However, if the shafts are grossly misaligned, the metal band will “walk-off” the belt, causing the coupling to come apart. The axial grooves have also been provided with an enlarged central portion such that the pins must be forced through the entrance of the axial groove and then “pop” into place in the central portion to give a tactile indication that the metal band is properly positioned with respect to the flexible belt.

In our U.S. patent application Ser. Nos. 08/742,372and 08/695,675, we have disclosed improved “lock-on” apparatus for improving the retention of the aforementioned metal retainer bands. This improved apparatus employs an axial groove for initially receiving a pin located on the underside of the metal retainer band and a circumferential groove opening into the axial groove and into which the retainer band pin may be rotated. In the embodiments illustrated in the referenced applications, the axial groove is bisected by a radial line which also bisects one of the lobes or projections of the flexible belt. The circumferential groove is relatively short, typically having been selected to be two times the width of the retainer ring pin. In practice, such apparatus must contend with vibrations, harmonics, rotation, misalignment and various stresses and forces on the component parts.

### SUMMARY

The following is a summary of various aspects and advantages realizable according to various embodiments of the invention. It is provided as an introduction to assist those skilled in the art to more rapidly assimilate the detailed design discussion which ensues and does not and is not intended in any way to limit the scope of the claims which are appended hereto in order to particularly point out the invention.

Accordingly, disclosed hereafter is a flexible coupling including a first hub having an inner face and a flexible insert having a plurality of exterior lobes and a plurality of interior lobes. A retainer ring is provided having an interior which engages the exterior lobes of the first hub, while a second hub has an exterior surface contoured to engage the interior lobes. The exterior and interior lobes may each have a rounded contour formed between two flat faces, which facilitates torque transmission.

### BRIEF DESCRIPTION OF THE DRAWINGS

An illustrative and presently preferred embodiment of the invention will now be described in detail in conjunction with the drawings of which:

FIG. 1 is an exploded perspective of a coupling according to a preferred embodiment;

FIG. 2 is a side view of the coupling of FIG. 1;

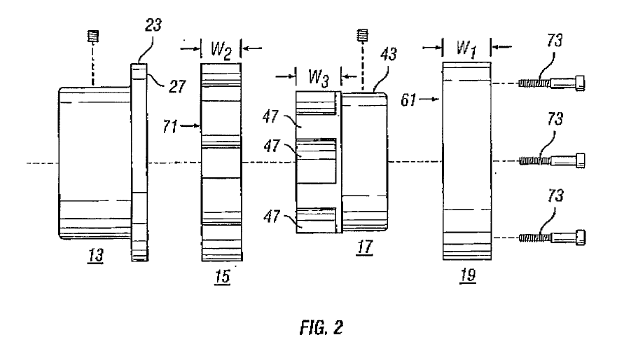

FIG. 3 is a perspective end view illustrating a hub, insert and retainer components in assembled relation;

FIG. 4 is a perspective view of the coupling in the assembled state;

FIG. 5 is a side cross sectional view of an embodiment according to the invention;

FIG. 6 is a side cross sectional view of an embodiment according to the invention; and

FIG. 7 is a side cross sectional view of an embodiment according to the invention.

### DETAILED DESCRIPTION OF PREFERRED EMBODIMENTS

The coupling of the illustrative embodiment includes a first hub 13, a flexible insert 15, a second hub 17 and a retainer member 19. The first hub 13 includes an interior bore, 22, a first cylindrical segment 21 and a mounting flange 23 having a circular outer edge 25. The face 27 of the flange 23 has a number of mounting holes 29 therein, each of which lies equally spaced on a circle of lesser diameter than that of the outer edge 25. Conventional fastening devices such as “screw” 27 may be used to secure the hubs to respective shafts.

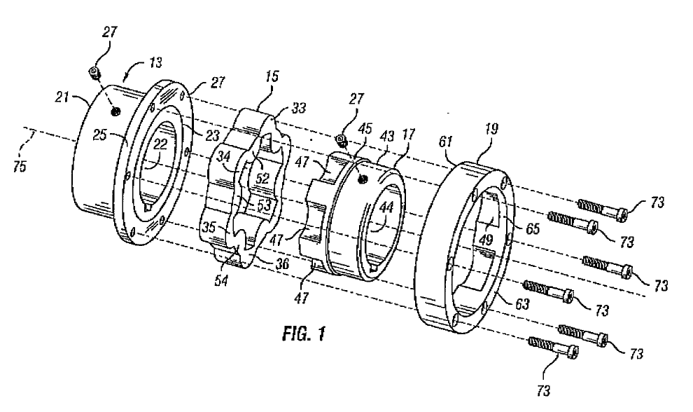

The insert 15 is preferably fabricated from a flexible material such as, for example, a suitable urethane, and is preferably split so as to facilitate “wraparound” installation. The outer surface 31 of the insert 15 features a number of equally spaced exterior lobes 33, 34, 35, 36, 37, 38 projecting therefrom. The lobes, e.g., 33, are formed about equally spaced radii extending from the center of the insert 15. The interior surface of the insert 15 features a number of interiorly projecting lobes 52, 53, 54, 55, 56, 57, which, in the embodiment of FIG. 1, alternate with the exterior lobes 33, 34, etc. In other words, as one proceeds about the circumference of the insert 15 one encounters a first exterior lobe 33, then an interior lobe 52, then a second exterior lobe 34, then a second interior lobe 53, etc.

The second hub 17 includes a cylindrical segment 43 and an insert-mounting segment or portion 45. The insert-mounting portion 45 includes a number of wells or receptacles 47 which are shaped and dimensioned to mate snugly with the interior lobes, e.g., 52, 53, of the insert 15. The hub 17 is preferably machined as a unitary part from a single piece of metal stock, but of course could be constructed in various other fashions. The second hub 17 further includes an interior bore 44, typically of circular cross section dimensioned to receive a shaft of cooperating apparatus.

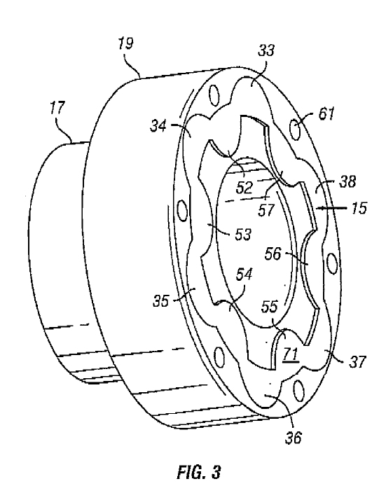

The interior 49 of the retainer 19 is specially contoured, shaped and dimensioned to receive and snugly mate with the exterior lobes, e.g., 33, 34, of the insert 15 when the coupling is in the assembled state. The retainer 19 has a first face 61 (FIG. 3), which receives and passes the insert 15 into mating position with the exterior lobes 33, 34, etc., and a second face 63 (FIG. 1) which includes a depending edge or flange portion 65, which prevents the insert 15 from passing through the retainer 19, i.e., holds the insert 15 in a position wherein the insert 15 is preferably encased by the retainer 19.

In the embodiment illustrated, the width “w₁” of the retainer and the width “w₂” of the insert are selected such that the face 71 of the insert 15 lies flush with the edge of the first face 61 of the retainer 19, such that both the insert's face 71 and the edge 61 lie adjacent the flange face 27 in the assembled state. Thus, in assembly, the retainer 19 “captures” the insert 15 and is then attached to the first hub 13 via a number of fastening devices such as threaded bolts 73.

As shown, for example, in FIG. 3, the width W₃ of the insert mating portion 45 of the second hub 17 is preferably selected such that its interior face terminates slightly short of the face of the insert 15. Thus, the second hub 17 does not protrude through the insert 15 or extend to a point where it might contact the flange face 27 of the first hub 13.

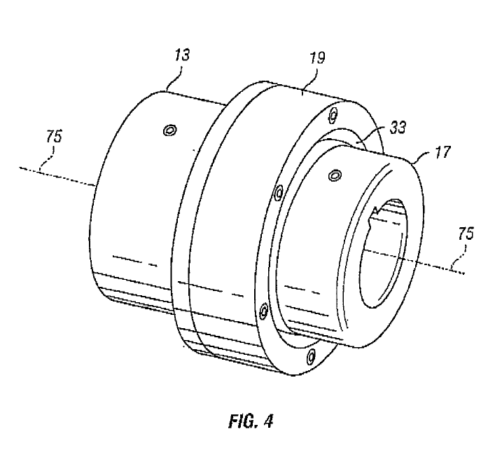

In operation in the assembled state (FIG. 4), the insert is snugly encased and transmits torque and absorbs minor misalignment without exerting axial thrusts on the cooperating shafts to which the first and second hubs 13, 17 are respectively attached. Thus, the insert 17 does not tend to exert forces on the hubs 13, 17 tending to move them parallel to the central axis 75 of rotation in typical applications. Such forces may cause a hub to move, for example, 15 thousandths of an inch, which is undesirable or unacceptable in certain applications.

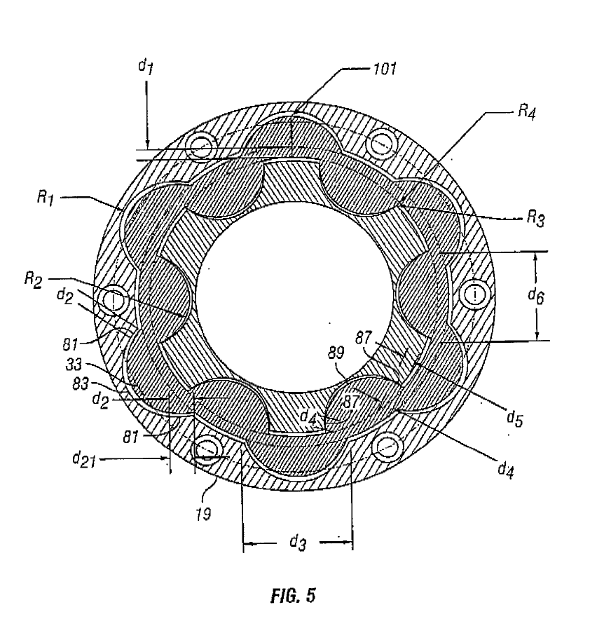

FIGS. 5-7 illustrate various design considerations according to a preferred embodiment of the invention. According to this illustrated embodiment, the insert 15 exhibits a constant shear section width dₗ. Each exterior lobe, e.g., 33, has respective flat sides 81 having a selected length d₂ and a central portion 83 between the two flat sides 81. The central portion 83 has a circular outer contour of radius R₁. Adjacent surfaces of the drive ring 19 are dimensioned to conform to the shape of the exterior lobe, e.g., 53, for example, in incorporating flat sections 85 adjacent the flat sides 81 of the outer lobes, the flat sections 85 having a length d₂₁. The width d₃ of each exterior lobe is the same.

Similar to the exterior lobes, each interior lobe, e.g., 52, has respective flat sides 87 of equal width d₄ and a central circular portion 89 connecting those sides 87 and having a radius R₂. The corner to comer width d₆ of each interior lobe, e.g., 52, is the same. Finally, the insert includes a split 101 in one of the outside lobes 103 to provide for wraparound installation.

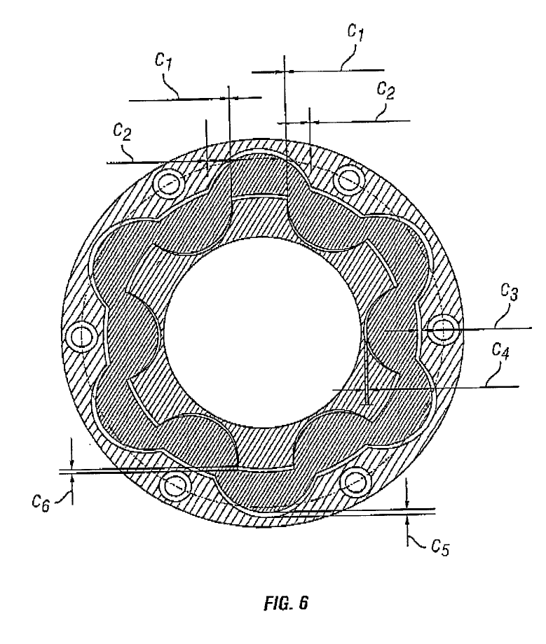

The dimensioning of the various widths and radii illustrated in FIG. 6, of course, varies, for example, with application and size of a particular coupling. An illustrative dimensioning in inches for a coupling of the size under consideration is as follows:

R₁=1.875

R₂=1.625

d₂=0.730

d₂₁=0.725

d₃=3.978

d₄=0.423

d₅=0.510

d₆=3.325

R₃=0.100

R₄=0.100

R₄ and R₃ are respectively inside corner lobe radii and outside comer hub wing radii implemented to resist tearing and cutting.

FIG. 6 illustrates various clearances of interest with respect to a coupling according to embodiment of FIGS. 5-7. The clearance c₂ is the clearance between the flat sides 87 of the interior lobes, e.g., 52, and the adjacent surfaces of the insert 15. The clearances c₂ are the clearances between the flat side portions 81 of the exterior lobes, e.g., 33, and the adjacent flat portions of the insert 15. The clearances c₅ and c₆ are the clearances between the diameter of the exterior lobes, e.g., 33, and the insert 15, while c₃ and c₄ are clearances between the diameter of the interior lobes, e.g., 52, and the insert 15. Illustrative values in inches for these clearances for a coupling, in which the outside diameter of the ring is about 14.72 inches, are:

c₁=0.030

c₂=0.035

c₃=0.060

c₄=0.060

c₅=0.060

c₆=0.060

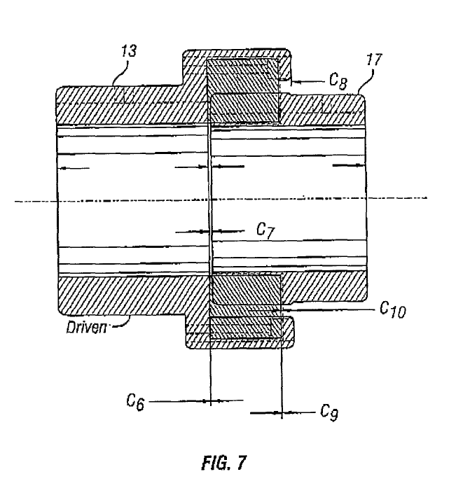

FIG. 7 illustrates additional dimensions of interest in an embodiment, according to FIG. 5. In particular, dimension c₈ represents the thickness of that part 65 of the retainer 19 which overlaps the insert 15. Dimension c₇ represents the clearance range between the opposing faces of the driving and driven hubs 17, 13. The clearance c₆ represents the distance by which the face of the driving hub 17 is set back from the face of the insert 15. Dimension c₉ represents the clearance between the side face of the insert 15 and the interior edge of the retainer 19. Dimension c₁₀ represents the clearance range between the face of the insert and the driven hub 13. Representative dimensions in inches for an illustrative coupling of the size under discussion are:

c₆=0.0200

c₇=0.090-0.310

c₈=0.5000

c₉=0.0200

c₁₀=0.0200-0.2700

Several observations may be made with respect to operation of the couplings according to various embodiments disclosed herein. First, the flat side surfaces on the interior and exterior lobes facilitate torque transmission. The coupling further provides free axial float, illustrated, for example, by clearance ranges c₇ and c₁₀ in FIG. 7, as well as relatively wider width W₂ of the insert and relatively wider wings “W₃” of the hub, for example, when compared to features of previous couplings such as ATR Sales' “A” or “M” series. In particular applications, the design enables the driving and driven shafts to be positioned at greater distances from one another than previous designs. In such case, for example, greater thermal growth of shafts can be accommodated than in previous systems.

Such couplings have the further advantage of combining advantageous aspects of both shear and compression couplings. In particular, the coupling operates normally in compression, which prevents exertion of axial thrusts, but can still shear to protect equipment in the event of lock-up or overload, etc. An example is the case of shredding apparatus used to shred recycled material. Occasionally, the material will include prohibited foreign objects which can lock the shredder. In such case the insert of a coupling according to the disclosed design will shear rather than break the associated equipment.

While the present invention has been described above in terms of specific embodiments, it is to be understood that the invention is not limited to the disclosed embodiments. The role of “driving” and “driver hubs” may be reversed and dimensioning adapted to particular sizes and conditions. Thus, the present invention is intended to cover various modifications and equivalent methods and structures included within the spirit and scope of the appended claims.

What is claimed:

1. A coupling comprising:
a first hub having an inner face;
a flexible insert having a plurality of exterior lobes and a plurality of interior lobes;
a retainer having an interior shaped and dimensioned to snugly receive said plurality of exterior lobes; and
a second hub having a portion thereof shaped and dimensional to snugly receive and mate with said plurality of interior lobes.

2. The coupling of claim 1 wherein said first hub has a cylindrical segment and wherein said face comprises the face of a flange formed on said cylindrical segment.

3. The coupling of claim 1 wherein said exterior and interior lobes each have a rounded contour symmetrically formed about respective radii of said insert.

4. The coupling of claim 1 wherein at least one exterior lobe comprises a first flat face and a circular portion.

5. The coupling of claim 1 wherein at least one interior lobe comprises a first flat face and a circular portion.

6. The coupling of claim 4 wherein said at least one exterior lobe further comprises a second flat face and wherein said circular portion lies between the first flat face and second flat face.

7. The coupling of claim 6 wherein said first and second flat faces are of equal length.

8. The coupling of claim 5 wherein said at least one interior lobe comprises a second flat face and said circular portion lies between said first and second flat face.
